(19) United States
(12) Patent Application Publication
(10) Pub. No.: US 2017/0157532 A1
(43) Pub. Date: Jun. 8, 2017

(54) RADIAL CHROMATOGRAPHY FOR CARBOHYDRATE SEPARATION

(71) Applicant: Cargill, Incorporated, Wayzata, MN (US)

(72) Inventors: Frank Georges Hendrick DEREZ, Sint-Pieters-Leeuw (BE); Joost KETSMAN, Oudenaarde (BE); Luigi NATALONI, Bologna (IT)

(21) Appl. No.: 15/323,751

(22) PCT Filed: Jul. 1, 2015
(86) PCT No.: PCT/US2015/038837

§ 371 Date: Jan. 4, 2017

(30) Foreign Application Priority Data
Jul. 4, 2014 (EP) 14175750.0

(51) Int. Cl. B01D 15/18; C13K 11/00; C13K 1/08; C13K 13/00; C13K 7/00

(52) U.S. Cl. CPC B01D 15/18; C13K 13/00; C13K 7/00; C13K 1/08; C13K 11/00

(57) ABSTRACT

The invention relates to a process for separating one or more carbohydrate from a composition wherein separating is done through radial chromatography. Preferably, the invention relates to a process for separating at least two carbohydrates from a composition wherein separating is done through radial chromatography, and wherein each of the at least two carbohydrates are collected in a purified form. The present invention relates to the use of radial chromatography for the separation of one or more carbohydrate from a composition and obtaining the one or more carbohydrate in a purified form.

### CROSS-REFERENCE TO RELATED APPLICATIONS

This application claims the benefit of European Patent Application Serial No. 14175750.0 filed Jul. 4, 2014, entitled RADIAL CHROMATOGRAPHY FOR CARBOHYDRATE SEPARATION, which application is hereby incorporated by reference herein in its entirety.

### FIELD OF THE INVENTION

The invention relates to a process for separating one or more carbohydrate from a composition wherein separating is done through radial chromatography. Preferably, the invention relates to a process for separating at least two carbohydrates from a composition wherein separating is done through radial chromatography, and wherein each of the at least two carbohydrates are collected in a purified form. The present invention relates to the use of radial chromatography for the separation of one or more carbohydrate from a composition and obtaining the one or more carbohydrate in a purified form.

### BACKGROUND OF THE INVENTION

Carbohydrates are widely used in the food and feed industry. They may be used in the form of purified powder carbohydrates, carbohydrate syrups with more or less purity, which are typically a mixture at more or less dry substance of carbohydrates or a syrup of one carbohydrate at high purity. There are plenty of raw materials for the production of carbohydrates; one main raw material for the production of various carbohydrates is plant starch. Starch is typically processed into various starch hydrolysates. Starch processing is well known in the art. Production of various carbohydrates requires several purification and separation steps to obtain desired final products.

Different purification and separation methods exist currently for purifying and separating carbohydrate out of a composition, in particular out of starch hydrolysate composition. These methods comprise filtration, ion exchange axial chromatography, the latter being widely used at industrial scale. Axial chromatography is a known process commonly used for separation of carbohydrates contained in a liquid solution by feeding such liquid solution through a fixed bed of an ion exchange column, followed by addition of elution water. The separation is carried out through a so-called axial chromatography, which typically uses columns that are of a cylindrical construction and the liquid solution flows axially through a separating medium bed retained in the column. The separation is achieved through a mass transfer phenomenon or mechanism wherein the eluent water is flowing through a part of the stationary resin together with the feed solution in a so-called mass transfer zone. The ion exchange resin can be anion or cation exchange or none charged resin of various bead size.

Such systems have a high pressure drop which results in restriction in the flow rate that can be applied and also results in limited productivity.

There is a need to improve current methods and/or find alternative methods which result in higher yield and/or higher efficiency and/or faster operation for separation of carbohydrates. The present invention provides for such method.

### SUMMARY OF THE INVENTION

The present invention relates to a process for separating one or more carbohydrate from a composition comprising the steps of:
a) Applying the composition comprising the one or more carbohydrate on a chromatographic separation system, and
b) Applying an eluent, and
c) Collecting one or more fractions comprising the one or more carbohydrate,
   wherein the chromatographic separation system is a radial chromatographic separation system.

Further the present invention relates to the use of radial chromatography for the separation of one or more carbohydrate from a composition and obtaining the one or more carbohydrate in a purified form.

### DETAILED DESCRIPTION

The present invention relates to a process for separating one or more carbohydrate from a composition comprising the steps of:
a) Applying the composition comprising the one or more carbohydrate on a chromatographic separation system, and
b) Applying an eluent, and
c) Collecting one or more fractions comprising the one or more carbohydrate,
   wherein the chromatographic separation system is a radial chromatographic separation system.

### Composition

The composition comprises the one or more carbohydrates and other components. Preferably, the composition comprises from 10 to 100 weight % (wt %), more preferably from 20 to 99 wt %, even more preferably from 20 to 95 wt %, even more preferably form 30 to 80 wt %, yet even more preferably from 40 to 70wt %, yet even more preferably from 40 to 60 wt % of the one or more carbohydrates, based on the dry substance of the composition.

Typically the composition has a dry substance of from 10 to 90%, preferably from 20 to 80%, more preferably from 30 to 70%, even more preferably from 40 to 65%, yet even more preferably from 45 to 65%, yet even more preferably from 50 to 65%, most preferably from 55 to 65%.

The other components of the composition can be various, depending mostly on the origin of the composition. They can be salts, catalysts, protein, fibres, fats and the like and their amount in the composition varies, again depending mostly on the origin of the composition. Preferably, the composition is produced from starch. Starch can be derived from cereals such as wheat, corn, sorghum, barley, rice, millet, oats, rye, triticale, amaranth, from sago, pea, potato, sweet potato, banana, tapioca, arrowroot, canna, and low amylose (containing no more that about 10% by weight amylose, preferably no more than 5% by weight amylose) or high amylose (containing at least about 40% by weight amylose) varieties thereof Genetically modified varieties of these crops are also suitable sources of starch. Preferably however, starch is derived from cereals, more preferably from wheat and/or corn.

Preferably the composition is obtained from starch liquefaction and partial or complete saccharification possibly followed by isomerisation and/or hydrogenation processes. Many carbohydrates can be generated from these process steps. This is well known in the art.

Preferably thus the composition is derived from a process wherein wheat and/or corn starch are liquefied, then saccharified, then possibly isomerised and/or hydrogenated to yield one or more of glucose, fructose, dextrose, maltose, sorbitol and mannitol.

The composition can also be produced by mixing one or more carbohydrates with water and other components such as salts, proteins, fat, fibres and the like.

### Carbohydrate

Carbohydrates may he selected from monosaccharides, disaccharides, oligosaccharides, dextrins, polyols and mixtures thereof Preferably they are selected form monosaccharides and/or disaccharides.

The monosaccharides include tetroses, pentoses, hexoses and ketohexoses. Typical monosaccharides include glucose, dextrose, fructose, galactose, ribose. Typical disaccharides include sucrose, maltose, trehalulose, trehalose, isomaltulose, melibiose, kojibiose, sophorose, laminaribiose, isomaltose, gentibiose, cellobiose, mannibiose, lactose, leucrose, maltulose, turanose and the like.

Polyols can be selected form the group of erythritol, xylitol, arabinitol, sorbitol, mannitol, iditol, galactitol, maltitol, isomaltitol, isomalt, lactitol and mixtures of two or more thereof.

Preferably the carbohydrates are at least glucose and fructose.

Preferably, the composition comprises based on the dry substance of the composition:
from 35 to 45 wt % glucose, preferably from 40 to 45 wt % glucose, and
from 45 to 55 wt %, preferably from 50 to 55 wt % fructose, and
from 0 to 10 wt %, preferably from 1 to 5 wt % of other components and/or other carbohydrates.

Otherwise preferably, the composition comprises based on the dry substance of the composition:
from 30 to 55 wt %, preferably from 33 to 52 wt %, more preferably from 35 to 50 wt %, even more preferably from 37 to 48 wt %, yet even more preferably from 40 to 45 wt % of fructose, and
from 40 to 65 wt %, preferably from 43 to 62 wt %, more preferably from 45 to 60 wt %, even more preferably from 47 to 58 wt %, yet even more preferably from 50 to 55 wt % of glucose, and
optionally from 0 to 10 wt %, preferably from 1 to 5 wt % of other components and/or other carbohydrates,

Otherwise preferably the carbohydrates are at least dextrose and maltose. Preferably the composition comprises based on the dry substance of the composition:
from 35 to 45wt % preferably from 40 to 45 wt % of dextrose, and
from 45 to 55wt %, preferably from 50 to 55 wt % of maltose, and
from 0 to 10 wt %, preferably from 1 to 5 wt % of other components and/or other carbohydrates.

Preferably the carbohydrates are at least sorbitol and mannitol. Preferably the composition comprises based on the dry substance of the composition:
from 35 to 45 wt %, preferably from 40 to 45 wt % of sorbitol, and
from 45 to 55 wt %, preferably from 50 to 55 wt % of mannitol, and
from 0 to 10 wt %, preferably from 1 to 5 wt % of other components and/or other carbohydrates.

The other components may be, as mentioned above, salts, catalysts, protein, fibres, fats and the like. The other carbohydrates may be trisaccharides, other oligosaccharides having a degree of polymerisation (i.e. the number of monomer units) of 4, 5 for example and above.

One or more fraction comprising the one or more carbohydrate are collected in step c) of the process. Said one or more fraction are enriched in the one or more carbohydrate, i.e. the amount of the one or more carbohydrate in the one or more collected fraction, based on the dry substance of the collected one or more fractions, is higher than the amount of the one or more carbohydrate in the composition, based on the dry substance of the composition. Preferably, the composition comprises at least two carbohydrates and step c) comprises collecting at least two fractions, each enriched in one of the at least two carbohydrates. More preferably the number of fractions collected corresponds to the number of different desired carbohydrates to be separated. Thus the process of the present invention is suitable to fractionate the composition to separate out/isolate or increase the purity of desired one or more carbohydrate.

Thus preferably, the present invention relates to a process for separating glucose and fructose from a composition comprising the steps of:
a) Applying the composition comprising glucose and fructose on a chromatographic separation system, and
b) Applying an eluent, and
c) Collecting one fraction enriched in glucose compared to the composition and one fraction enriched in fructose compared to the composition,
   wherein the chromatographic separation system is a radial chromatographic separation system.

Thus preferably, the present invention relates to a process for separating dextrose and maltose from a composition comprising the steps of:
a) Applying the composition comprising dextrose and maltose on a chromatographic separation system, and
b) Applying an eluent, and
c) Collecting one fraction enriched in dextrose compared to the composition and one fraction enriched in maltose compared to the composition,
   wherein the chromatographic separation system is a radial chromatographic separation system.

Thus preferably, the present invention relates to a process for separating sorbitol and mannitol from a composition comprising the steps of:
a) Applying the composition comprising sorbitol and mannitol on a chromatographic separation system, and
b) Applying an eluent, and
c) Collecting one fraction enriched in sorbitol compared to the composition and one fraction enriched in mannitol compared to the composition,
   wherein the chromatographic separation system is a radial chromatographic separation system.

### Radial Chromatography

The process of the present invention is characterised in that the chromatographic separation system is a radial chromatographic separation system, or radial chromatography, also known as radial flow, co-axial or horizontal flow chromatography. The terms radial chromatographic separation system, or radial chromatography, also known as radial flow, co-axial or horizontal flow chromatography can be used interchangeably. This type of chromatographic system is opposed to axial chromatographic system. In axial chromatography, the sample and the eluent (i.e. the feed streams into the chromatographic system) and the collected fractions (i.e. the products streams out of the chromatographic system) flow in substantially the same direction, typically vertically from top to bottom of the chromatographic system. Radial chromatography is characterised in that the sample and eluent fluid flow in a direction that is perpendicular to the longitudinal axis of the chromatographic system (typically column), regardless of the position of the chromatographic system relative to the work bench or support stands or other equipment used to support or stack the system. Thus the feed streams and the products streams do not flow in the same direction in and out the chromatographic system. Typically the feed stream enters the chromatographic system (typically column) horizontally and the products streams leave the chromatographic system with a substantially different angle, typically vertically, compared to the feed stream. Currently radial chromatography has limited use in high performance chromatography such as in pharmaceutical industry to separate pharmaceutical components (proteins, antibodies, antioxidants) from impurities. It has now been found that this type of chromatography is suitable to separate one or more carbohydrates from a composition.

Preferably the chromatographic separation system is based on affinity chromatography. Preferably it is ion exchange chromatography. The composition is applied to the chromatographic system and subsequently, an eluent is applied. Preferably a liquid eluent/mobile phase is used for the separation. Similar eluent can be used in radial chromatography as in axial chromatography. Eluent used in axial chromatography are well known in the art, they are either pure solvents or mixtures of different solvents. Preferably the eluent is demineralised water.

Preferably the chromatography is performed on a chromatography column, with no limitation to size, width or other physical properties of a column. It is well known in the art that a chromatography column should have a well-defined width and height.

Thus the present invention relates to a process for separating one or more carbohydrate from a composition comprising the steps of:
a) Applying the composition comprising the one or more carbohydrate on a chromatographic column, and
b) Applying an eluent, preferably demineralised water, and
c) Collecting the one or more fractions comprising the one or more carbohydrate
   wherein the chromatographic separation system is a radial chromatographic separation system.

The resin present as a stationary phase in the column should be packed well. It lies within the skills of the person skilled in the art to pack a column in a way to perform an efficient chromatographic separation. The resin is in the form of fine beads. Preferably, the resin beads have a diameter of from 20 to 360 μm, more preferably from 20 to 150 μm, even more preferably from 30 to 150 μm, yet even more preferably from 30 to 80 μm, yet even more preferably from 30 to 75 μm. In axial chromatography due to pressure drop limitation resin beads diameter is typically of from 200 to 360μ.

The speed with which the mobile phase flows through the chromatographic system is measured by its flow rate, expressed in Bed Volume per hour (BV/h). This is a common term in the art. It has been found surprisingly that with radial chromatography, the flow rate of the feed stream can be as high as from 15 to 40 BV/h. Preferably the flow rate is from 20 to 40, more preferably from 30 to 35 BV/h. Typical flow rate in axial chromatography is from 1 to 5 BV/h.

Compared to axial chromatography, it has been found that, by using radial chromatography, the productivity of the separation process of carbohydrates from a composition as described herein can be surprisingly increased significantly. The term productivity relates to the amount of a specific carbohydrate, or a mixture of specific carbohydrates, that is obtained per litre of resin and per hour of processing time. The productivity of the process of the present invention is at least 5 to 20 times, preferably at least 10 to 20 times, more preferably at least 15 to 20 times higher than the same process operated under similar conditions with an axial chromatographic separation system and for a similar purity of the collected one or more carbohydrate. This is an important development in the carbohydrates industry as it means that to remain at current productivity rate, i.e. productivity rates obtained with axial chromatography, the amount of resin used can be reduced by at least 5 to 20 times, preferably at least 10 to 20 times, more preferably at least 15 to 20 times. Less resin means less ecological impact, need of less washing solutions to clean the resin and the like. This might also result in less use of eluent, reduced need of energy which again has a beneficial ecological impact and a beneficial impact on the cost of the process.

Preferably step a) of the process is performed at a temperature of from 20 to 60° C., more preferably from 25 to 55° C., even more preferably from 30 to 50° C., yet even more preferably from 35 to 45° C. Preferably, the composition is first heated to the desired temperature before being applied to the chromatographic separation system. Preferably, the mobile phase is also first heated before being added to the chromatographic separation system.

Collecting the one or more carbohydrate can be done as desired. The one or more carbohydrates can be collected separately from each other, in a more or less purified form or can be collected as a mixture of one or more carbohydrates. It lies well within the skills of the person skilled in the art to modify the process conditions in order to obtain the desired composition of the one or more collected fraction.

The one or more collected carbohydrate is typically collected as a syrup having a higher purity in said carbohydrate. Preferably, the process collects each of the one or more carbohydrate at a purity of from 40 to 70 wt %, preferably from 45 to 65 wt %, more preferably from 50 to 60 wt %, based on the dry substance of the collected material.

The collected carbohydrate can be further treated such as dried, crystallised, and can be used in food, feed, cosmetic, pharmaceutical, industrial compositions and the like.

Preferably the process is run in batch mode.

The present invention further relates to the use of radial chromatography for the separation of one or more carbohydrate from a composition and obtaining the one or more carbohydrate in a purified form. It has been found that the use of radial chromatography for the separation of carbohydrates from a composition increases substantially the productivity of the separation in comparison with separation done by axial chromatography.

The present invention will be further illustrated in the following examples.

### EXAMPLES

### Example 1

A composition is fed into a chromatography column. The column is packed well with resin. Elution is done with demineralized water. The composition comprises 41.9% of fructose, 51.7% of dextrose and 6.4% of other components (trisaccharides, primarily maltotriose, DP4 oligosaccharides (i.e. oligosaccharides with 4 monomer units), primarily maltotetraose and higher saccharides).

One trial is done on an axial chromatography and one trial is done on a radial chromatography. The process is run in batch mode.

The composition is fed onto the column at a temperature of 52° C. Composition and eluent flow rate is given below.

The details of each chromatographic separation system are given in table 1.

TABLE 1

| | Axial | Axial | Axial | Radial |
|---|---|---|---|---|
| | Chromatography | Chromatography | Chromatography | Chromatography |
| Column type | Diaion UBK555 | Diaion UBK555 | Diaion UBK555 | Dowex 50WX4 |
| | (Mitsubishi) | (Mitsubishi) | (Mitsubishi) | (Dow) |
| Resin beads | 220 | 220 | 220 | 35-75 |
| diameter (μm) | | | | |
| Resin BV (ml) | 135 | 50 | 50 | 135 |
| Composition | 60.5 | 61 | 61 | 60.9 |
| Brix | | | | |
| Flow rate | 1 | 29.67 | 6.94 | 30.65 |
| (BV/h) | | | | |
| Purity (wt % of | 65.1 | 57.6 | 58 | 65.5 |
| fructose in | | | | |
| product) | | | | |
| Productivity | 0.014 | 0.010 | 0.027 | 0.297 |
| (kg of | | | | |
| fructose/l of | | | | |
| resin/h) | | | | |

1. A process to separate one or more carbohydrate from a composition comprising the steps of:
Applying the composition comprising the one or more carbohydrate on a chromatographic separation system, and
Applying an eluent, and
Collecting one or more fractions comprising the one or more carbohydrate,
wherein the chromatographic separation system is a radial chromatographic separation system.

2. The process of claim 1, wherein the composition comprises from 10 to 100 weight % of carbohydrate based on dry substance of the composition.

3. The process of claim 1, wherein the chromatographic system comprises beads having a diameter of from 20 to 150 μm.

4. The process of claim 1, wherein the composition is applied at a flow rate of from 15 to 40 BV/h, preferably from 20 to 40 BV/h, preferably at a flow rate of from 30 to 35 BV/h.

5. The process of claim 1, wherein the carbohydrate composition comprises at least glucose and fructose.

6. The process of claim 1, wherein the carbohydrate composition comprises:
From 35 to 45 weight % of glucose, and
From 45 to 55 weight % of fructose, and
From 0 to 10 weight % of other components and/or carbohydrates.

7. The process of claim 1, wherein the carbohydrate composition comprises
From 30 to 55 weight % of fructose, and
From 40 to 65 weight % of glucose, and
From 0 to 10 weight % of other components and/or carbohydrates.

8. The process of claim 1, wherein the carbohydrate composition comprises at least dextrose and maltose.

9. The process of claim 1, wherein the carbohydrate composition comprises at least sorbitol and mannitol.

10. The use of radial chromatography to separate one or more carbohydrate from a composition comprising said one or more carbohydrate.

11. The use according to claim 10 to increase the productivity of the separation of said one or more carbohydrate, compared to a separation of said one or more carbohydrates with axial chromatography.
